(19) United States
(12) Patent Application Publication
(10) Pub. No.: US 2014/0104491 A1
(43) Pub. Date: Apr. 17, 2014

(54) PROTECTIVE SHELL HAVING SHUTTER PRESSING STRUCTURE AND IMAGE CAPTURING METHOD

(71) Applicant: OZAKI INTERNATIONAL CO., LTD., New Taipei City (TW)

(72) Inventor: Keng-Yuan LIU, New Taipei City (TW)

(21) Appl. No.: 13/939,532

(22) Filed: Jul. 11, 2013

(30) Foreign Application Priority Data
Oct. 15, 2012 (TW) 101219870

(51) Int. Cl. H04N 5/225

(52) U.S. Cl. CPC H04N 5/2252
USPC 348/376

(57) ABSTRACT

A protective shell having a shutter pressing structure and an image capturing method are provided. The protective shell is used for housing a handheld electronic device. The handheld electronic device includes an audio connection port and a camera module. The protective shell includes a shell body, a shutter button, an audio connector and a trigger circuit. The audio connector is used for being coupled to and signal-connected with the audio connection port. The trigger circuit is used for transmitting a shutter signal to the camera module through the audio connector and the audio connection port when the shutter button is pressed. Thus, the user can conveniently hold the protective shell to capture images just like using a camera.

### CROSS-REFERENCES TO RELATED APPLICATIONS

This non-provisional application claims priority under 35 U.S.C. §119(a) on Patent Application No. 101219870 filed in Taiwan, R.O.C. on Oct. 15, 2012, the entire contents of which are hereby incorporated by reference.

### BACKGROUND

1. Technical Field

The disclosure relates to a protective shell, and more particularly to a protective shell having a shutter pressing structure and an image capturing method.

2. Related Art

Like personal computers, smart phones can install third-party software to expand functions, and thus have high expandability in terms of applications. In addition, smart phones each include a touch screen, providing an intuitive operation interface for handwriting input or manipulation, which is popular with the users. Consequently, smart phones have become widely popular recently.

Nowadays, most smart phones are equipped with a lens module on the back surface thereof, and a user can capture images with the lens module and image capturing software installed on the mobile phone. During image capturing, the user points the lens module towards a scene to be captured with the assistance of the screen of the smart phone, and then touches the image capturing button on the screen with a finger, so as to capture an image.

When a user wants to capture an image of themselves, they usually holds the smart phone using their thumb and middle finger, with the lens module of the smart phone facing themselves, and then touch the screen with a forefinger. In this case, the phone cannot be held stable by the thumb and middle finger, and the user cannot see the screen, thus being unable to know whether the finger will touch the desired position on the screen. Consequently, the image capturing method is rather inconvenient, and the quality of images captured is undesirable.

In view of the above problems, a feasible solution needs to be provided to achieve a steady image capturing method without changing the appearance of the smart phone, so as to take high quality photographs.

### SUMMARY

Accordingly, the disclosure is directed to a protective shell having a shutter pressing structure and an image capturing method of a handheld electronic device, where the protective shell is used for housing the handheld electronic device to protect the case of the handheld electronic device from being scratched or damaged, and make it convenient for a user to hold the handheld electronic device to capture images.

An embodiment provides a protective shell having a shutter pressing structure, for housing a handheld electronic device. The handheld electronic device includes an audio connection port and a camera module. The protective shell includes a shell body, a shutter button, an audio connector and a trigger circuit.

The shell body includes an accommodating space for accommodating the handheld electronic device. The shutter button is located on one side of the shell body opposite to the accommodating space. The audio connector is located on one side of the shell body adjacent to the accommodating space, and used for being coupled to and signal-connected with the audio connection port when the handheld electronic device is disposed in the accommodating space. The trigger circuit is connected electrically between the shutter button and the audio connector, and used for transmitting a shutter signal to the camera module through the audio connector and the audio connection port of the handheld electronic device when the shutter button is pressed.

Another embodiment provides an image capturing method using a handheld electronic device disposed in a protective shell. The handheld electronic device includes an audio connection port and a camera module. The protective shell includes a shutter button, a trigger circuit and an audio connector. The image capturing method includes: inserting the audio connector into the audio connection port; when the shutter button is pressed, triggering the trigger circuit; when the trigger circuit is triggered, the trigger circuit generating a shutter signal; and the trigger circuit transmitting the shutter signal to the audio connection port through the audio connector, so that the handheld electronic device drives, according to the shutter signal, the camera module to capture an image.

The protective shell having a shutter pressing structure and the image capturing method according to the disclosure can make it convenient for the user to press the shutter button to capture images while holding the protective shell. Since the shutter button is located outside the shell body, the user can conveniently press the shutter button to capture images without touching the screen of the handheld electronic device. Additionally, when holding the protective shell, the user manipulates the handheld electronic device to capture images like using an ordinary camera. Therefore, the protective shell can be stably held by the user, and maintains the use experience of the camera.

### BRIEF DESCRIPTION OF THE DRAWINGS

The disclosure will become more fully understood from the detailed description given herein below for illustration only, and thus not limitative of the disclosure, wherein:

FIG. 1 is a schematic three-dimensional view of a protective shell and a handheld electronic device according to a first embodiment;

FIG. 2 is another schematic three-dimensional view of the protective shell and the handheld electronic device according to the first embodiment;

FIG. 3A is a schematic circuit diagram of a trigger circuit according to the first embodiment;

FIG. 3B is a schematic circuit diagram of a shutter detection circuit of the handheld electronic device according to the first embodiment;

FIG. 4 is a schematic three-dimensional view of a protective shell according to a second embodiment;

FIG. 5 is a schematic circuit diagram of a trigger circuit according to the second embodiment;

FIG. 6 is a front view of a protective shell according to a third embodiment;

FIG. 7A is a schematic circuit diagram of a trigger circuit according to a fourth embodiment;

FIG. 7B is another schematic circuit diagram of the trigger circuit according to the fourth embodiment;

FIG. 7C is a schematic circuit diagram of a shutter detection circuit according to the fourth embodiment;

FIG. 8 is a schematic three-dimensional view of a protective shell and a handheld electronic device according to a fifth embodiment; and

FIG. 9 is a flowchart of an image capturing method using the protective shell 1 and the handheld electronic device 50 according to the first to fourth embodiments.

### DETAILED DESCRIPTION

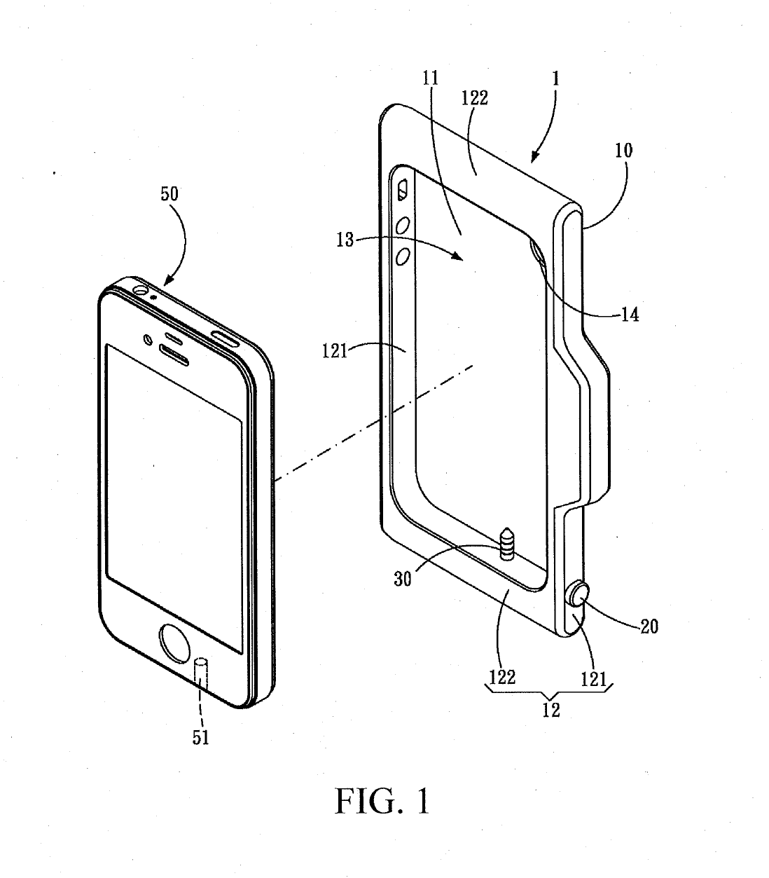

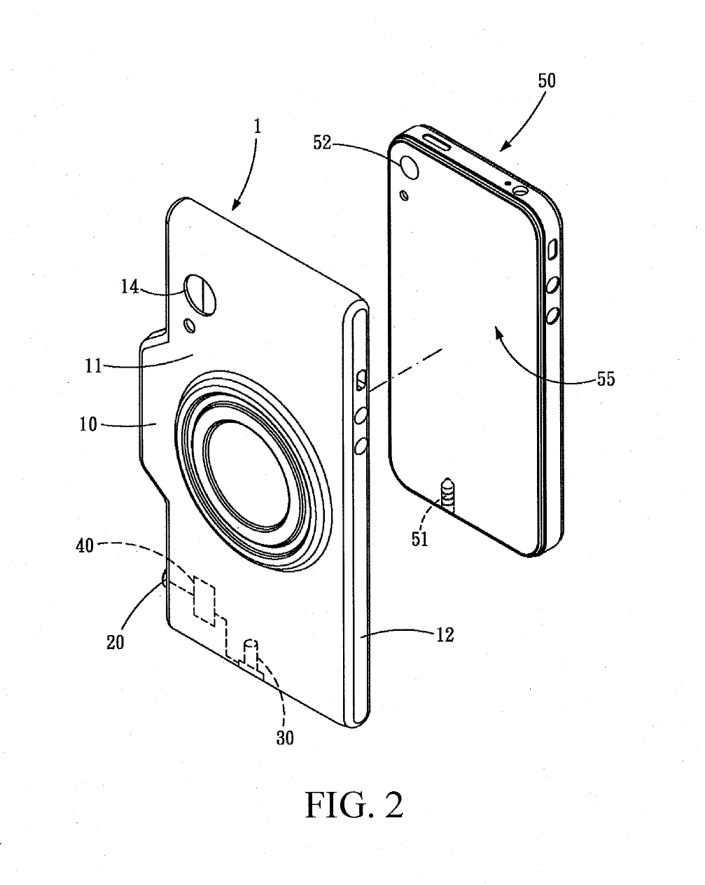

FIG. 1 is a schematic three-dimensional view of a protective shell 1 and a handheld electronic device 50 according to a first embodiment. FIG. 2 is another schematic three-dimensional view of the protective shell 1 and the handheld electronic device 50 according to the first embodiment.

Please refer to FIG. 1 and FIG. 2, in which the protective shell 1 includes a shell body 10, a shutter button 20, an audio connector 30 and a trigger circuit 40, and the protective shell 1 is adapted to house a handheld electronic device 50 therein. The handheld electronic device 50 includes an audio connection port 51 and a camera module 52. Here, the handheld electronic device 50 may substantially be a mobile phone, a GPS navigator or a multimedia player.

The shell body 10 includes an accommodating space 13 for accommodating the handheld electronic device 50. The shutter button 20 is located on one side of the shell body 10 opposite to the accommodating space 13. The audio connector 30 is located on one side of the shell body 10 adjacent to the accommodating space 13, and used for being coupled to and signal-connected with the audio connection port 51 when the handheld electronic device 50 is disposed in the accommodating space 13. The trigger circuit 40 is connected electrically between the shutter button 20 and the audio connector 30, and used for transmitting a shutter signal to the camera module 52 through the audio connector 30 and the audio connection port 51 of the handheld electronic device 50 when the shutter button 20 is pressed.

Here, the handheld electronic device 50 of this embodiment is approximately in the shape of, for example, a flat cuboid; however, the embodiments are not limited thereto, and other shapes may also be adopted. Additionally, the appearance of the protective shell 1 may be designed corresponding to the shape of the handheld electronic device 50, and is not limited to the appearance of the protective shell 1 shown in FIG. 1.

As shown in FIG. 1, the shell body 10 may include a bottom wall portion 11 and a side wall portion 12 extending from a periphery of the bottom wall portion 11. Whereby, the bottom wall portion 11 and the side wall portion 12 define the accommodating space 13 for accommodating the handheld electronic device 50. The audio connection port 51 is located at the bottom of the handheld electronic device 50 for the convenience of corresponding insertion of the audio connector 30 of the protective shell 1; however, the embodiments are not limited thereto, and the position of the audio connector 30 may be determined based on the position of the audio connection port 51.

As shown in FIG. 2, the handheld electronic device 50 has a back surface 55 for abutting the bottom wall portion 11 of the shell body 10 when the handheld electronic device 50 is disposed in the accommodating space 13, the camera module 52 being located on the back surface 55. The bottom wall portion 11 of the shell body 10 is provided with a through hole 14 for exposing the camera module 52 when the handheld electronic device 50 is disposed in the protective shell 1.

Please refer to FIG. 1 again, in which the side wall portion 12 includes two opposite first side walls 121 and two opposite second side walls 122, which are connected to one another in a staggered manner. Here, the angles between the first side walls 121 and the second side walls 122 are approximately 90°, that is to say, the accommodating space 13 is approximately a rectangular cubic space.

In some embodiments, as shown in FIG. 1, the shutter button 20 is located on one end of the first side wall 121 of the side wall portion 12, and the through hole 14 is located on the bottom wall portion 11 and corresponding to the other end of the first side wall 121. Thus, when a user holds the shell body 10, the hand pressing the shutter button 20 will not block the through hole 14 and the camera module 52.

Additionally, since the shutter button 20 is located on the first side wall 121, the user may hold the protective shell 1 with one hand and press the shutter button 20 with a finger, making it convenient to capture images; and the user can stably hold the protective shell 1 to prevent shaking during image capturing, thereby improving the quality of images captured.

In some embodiments, as shown in FIG. 1, the shutter button 20 is approximately cylindrical-shaped; however, the embodiments are not limited thereto. The shutter button 20 may be a push switch having an on state and an off state, where when the shutter button 20 is pressed, it is in the on state; otherwise, it is in the off state.

In some embodiments, as shown in FIG. 1, the audio connector 30 is located on one side of the second side wall 122 adjacent to the accommodating space 13. When the handheld electronic device 50 is accommodated in the accommodating space 13, the audio connector 30 may be matched with the audio connection port 51, so that the audio connector 30 may be inserted into the audio connection port 51 to achieve signal connection.

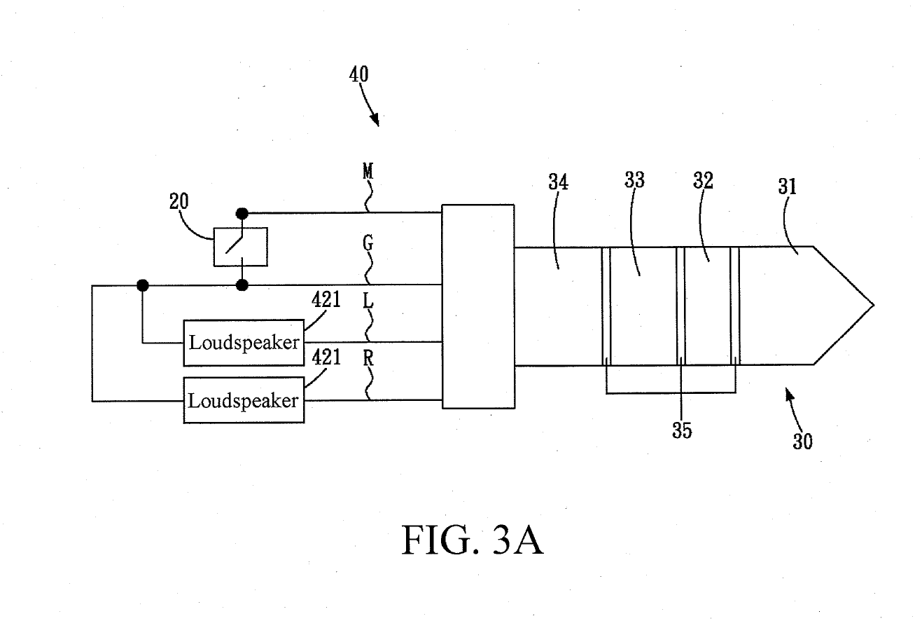

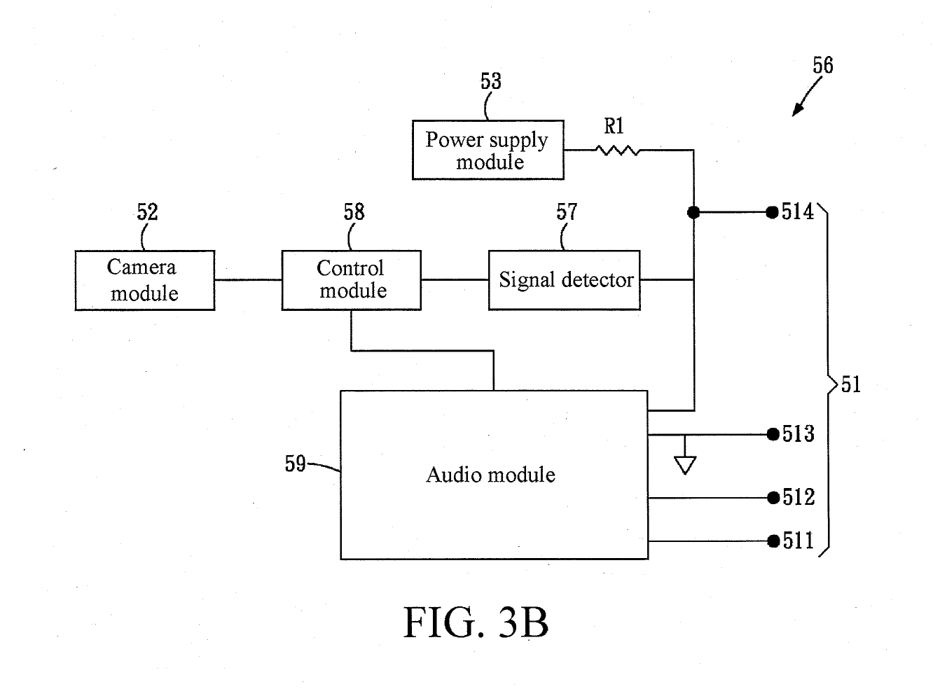

FIG. 3A is a schematic circuit diagram of the trigger circuit 40 according to the first embodiment.

Please refer to FIG. 2 and FIG. 3A, in which the trigger circuit 40 is connected electrically between the audio connector 30 and the shutter button 20, and used for generating a shutter signal when the shutter button 20 is in the on state, and transmitting the shutter signal to the audio connector 30.

As shown in FIG. 3A, the audio connector 30 has a plurality of electrical contacts, which are a left-channel contact 31, a right-channel contact 32, a ground contact 33 and a microphone contact 34 that are sequentially arranged in this embodiment. Here, an insulating portion 35 is provided between any two electrical contacts to isolate electrical signals of the two electrical contacts.

The left-channel contact 31 is connected electrically to a left-channel wire L; the right-channel contact 32 is connected electrically to a right-channel wire R; the ground contact 33 is connected electrically to a ground wire G; the microphone contact 34 is connected electrically to a microphone wire M. The shutter button 20 is connected electrically between the microphone wire M and the ground wire G, to cause a short circuit between the microphone wire M and the ground wire G when the shutter button 20 is in the on state, so that the microphone wire M and the ground wire G have the same voltage level (otherwise, have different levels). Here, the shutter signal refers to the voltage level change between the microphone wire M and the ground wire G.

In an embodiment, the trigger circuit 40 further includes an acoustic module 42. The acoustic module 42 is connected electrically to the audio connector 30, and used for receiving an audio signal output by the audio connection port 51 of the handheld electronic device 50, and converting the audio signal into an acoustic wave.

In FIG. 3A, the acoustic module 42 includes two loudspeakers 421, where one of the loudspeakers 421 is connected electrically between the right-channel wire R and the ground wire G, and the other loudspeaker 421 is connected electrically between the left-channel wire L and the ground wire G, so as to correspondingly output a right-channel or left-channel stereo signal respectively.

Here, although FIG. 3A exemplarily shows two loudspeakers 421, the embodiments are not limited thereto, and the acoustic module 42 may include only one loudspeaker 421 correspondingly connected to the right-channel wire R or the left-channel wire L to output the sound of a single channel only.

In this embodiment, the loudspeaker 421 may be a moving-coil loudspeaker, an electrostatic loudspeaker, a planar-magnetic loudspeaker or a balance-armature loudspeaker.

FIG. 3B is a schematic circuit diagram of the shutter detection circuit 56 of the handheld electronic device 50 according to the first embodiment.

As shown in FIG. 3B, the shutter detection circuit 56 includes an audio connection port 51, a power supply module 53 and a signal detector 57.

Please refer to FIG. 1, FIG. 3A and FIG. 3B, in which the audio connection port 51 includes a left-channel pin 511, a right-channel pin 512, a ground pin 513 and a microphone pin 514. When the audio connection port 51 is coupled to and signal-connected with the audio connector 30, the left-channel pin 511 is connected electrically to the left-channel contact 31, the right-channel pin 512 is connected electrically to the right-channel contact 32, the ground pin 513 is connected electrically to the ground contact 33, and the microphone pin 514 is connected electrically to the microphone contact 34.

As shown in FIG. 3B, the microphone pin 514 is connected electrically to the power supply module 53, so that the microphone pin 514 can obtain a high voltage level (which is not a ground level) provided by the power supply module 53. The microphone pin 514 is further connected electrically to the signal detector 57. When the shutter button 20 is in the off state, the signal detector 57 may detect that the microphone pin 514 is at the high voltage level. On the contrary, when the shutter button 20 is in the on state, the signal detector 57 may detect that the microphone pin 514 is at the same voltage level (that is, the ground level) as that of the ground pin 513, and thus detect the shutter signal (that is, the voltage change). Consequently, the handheld electronic device 50 can learn according to the shutter signal that the shutter button 20 is pressed.

As shown in FIG. 3B, the handheld electronic device 50 further includes a control module 58 and an audio module 59.

The control module 58 is signal-connected to the signal detector 57 to receive a detection result of the signal detector 57 on whether the shutter signal is received. The control module 58 is further signal-connected to the camera module 52, so as to enter a camera mode when it is determined that the signal detector 57 receives the shutter signal, and control the camera module 52 to capture images.

The audio module 59 is signal-connected to the control module 58, the left-channel pin 511, the right-channel pin 512, the ground pin 513 and the microphone pin 514, and controlled by the control module 58 to transmit the audio signal to the two loudspeakers 421 through the left-channel pin 511, the right-channel pin 512 and the ground pin 513.

Here, the control module 58 may substantially be a processor or central processing unit of any architecture. The audio module 59 may substantially be an audio codec chip, including signal processors such as an analog-to-digital converter, a digital-to-analog converter and an amplifier. The power supply module 53 not only provides the voltage level for the microphone pin 514, but may further provide electric power required for operation of elements in the handheld electronic device 50. Additionally, the handheld electronic device 50 may further include components such as a memory, a screen and a communication chip, which will not be described in detail herein.

In some embodiments, as shown in FIG. 3B, a resistor R1 may further be connected electrically between the power supply module 53 and the microphone pin 514 to provide a current limiting function.

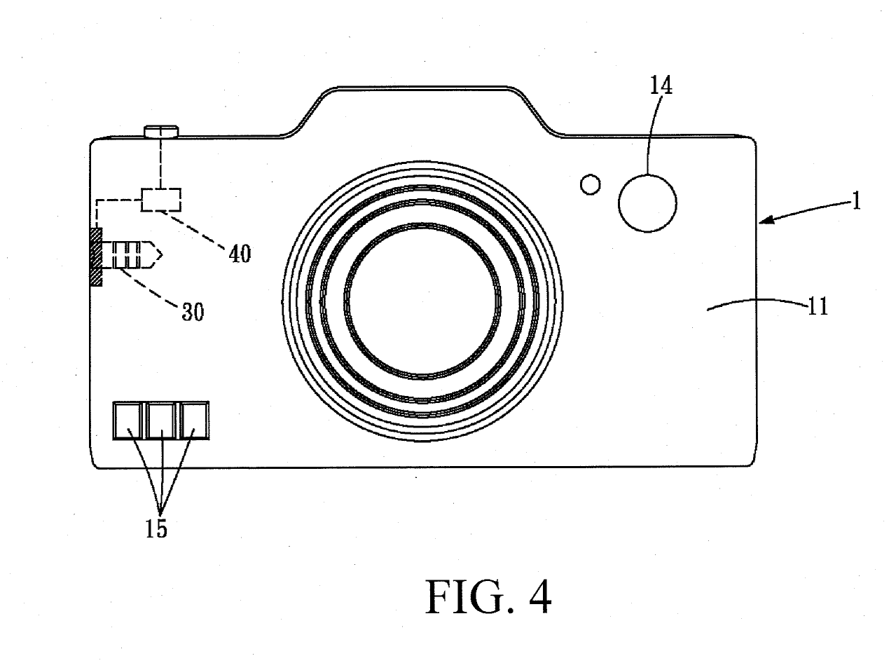

FIG. 4 is a schematic three-dimensional view of a protective shell 1 according to a second embodiment.

As shown in FIG. 4, the protective shell 1 and the handheld electronic device 50 of this embodiment are approximately the same as those of the first embodiment, except that the protective shell 1 further includes at least one control key 15, located on the side of the shell body 10 opposite to the accommodating space 13. Here, three control keys 15 are provided by way of example; however, the embodiments are not limited thereto.

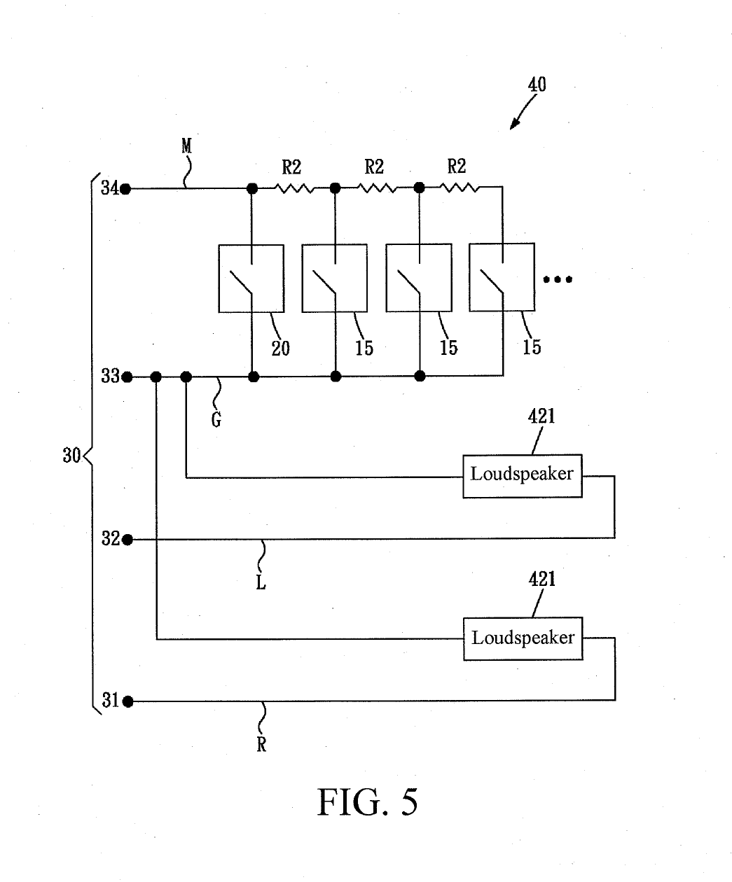

FIG. 5 is a schematic circuit diagram of the trigger circuit 40 according to the second embodiment.

As shown in FIG. 5, the control keys 15 are connected electrically to the audio connector 30, and used for transmitting a control signal (that is, according to the voltage change between the microphone wire M and the ground wire G caused when the control keys 15 are in the on state) to the handheld electronic device 50 through the audio connector 30 and the audio connection port 51 when control keys 15 are pressed. The control keys 15 are connected electrically between the microphone wire M and the ground wire G. A resistor R2 is provided between ends of any neighboring two control keys which are connected electrically to the microphone wire M, and a resistor R2 is also provided between one end of the shutter button 20 and one end of the neighboring control key 15 which are connected electrically to the microphone wire M. Thus, the control keys 15 and the shutter button 20 may form a coded switches group. That is to say, the signal detector 57 (as shown in FIG. 3B) may distinguish different combinations of the control keys 15 and the shutter button 20 respectively in the on state or the off state according to the voltage division level caused by the resistors R1 and R2.

Therefore, the control module 58 (as shown in FIG. 3B) may perform different operations according to the pressing states of the control keys 15 and the shutter button 20 detected by the signal detector 57. For example, when the handheld electronic device 50 is in a music playing mode, music playing (such as song selection, pause, fast forward, or volume adjustment) may be controlled according to pressing of the control keys 15. For another example, according to pressing of the control key 15, the handheld electronic device 50 may control the focal length (that is, zoom in/out) in the camera mode.

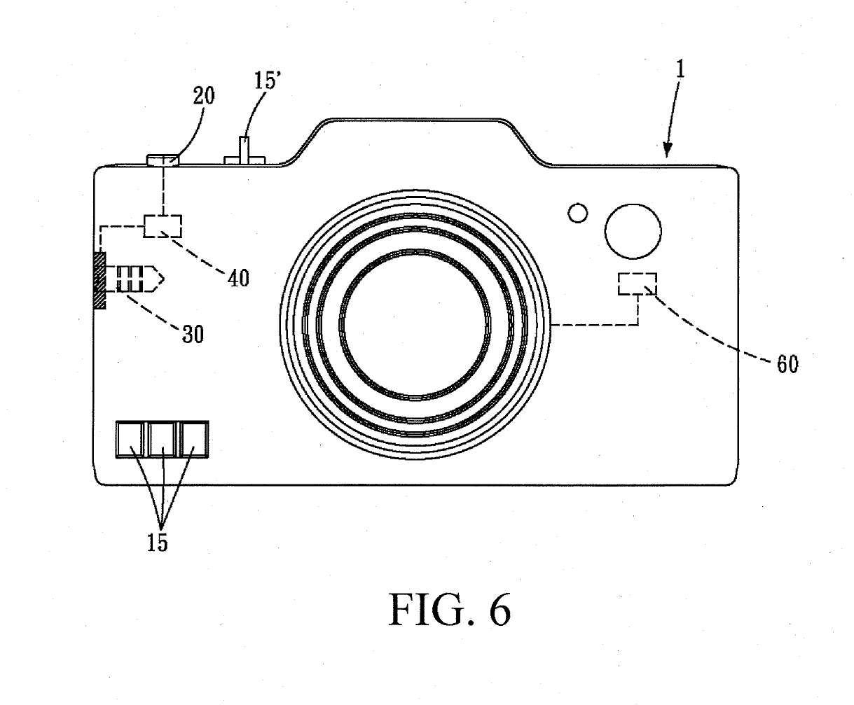

FIG. 6 is a front view of a protective shell 1 according to a third embodiment.

As shown in FIG. 6, the protective shell 1 and the handheld electronic device 50 of this embodiment are approximately the same as those of the first embodiment or the second embodiment, except that the protective shell 1 further includes a power supply module 60, connected electrically to the loudspeakers 421, and for supplying extra electric power to the loudspeakers 421, so as to drive the loudspeakers 421 that require an external power supply. Here, the power supply module 60 may include a charging circuit and a rechargeable battery; however, the embodiments are not limited thereto, and the power supply module 60 may be a non-rechargeable battery such as an alkaline battery.

Furthermore, in some embodiments, the number of the control keys 15 may be two, which are respectively corresponding to operations of zooming in and out. The control keys 15 may be disposed on the first side wall 121 along with the shutter button 20, and adjacent to the shutter button 20. Here, the two control keys 15 may be implemented by a two-way joystick 15′ (as shown in FIG. 6) to adapt to the habits of camera users.

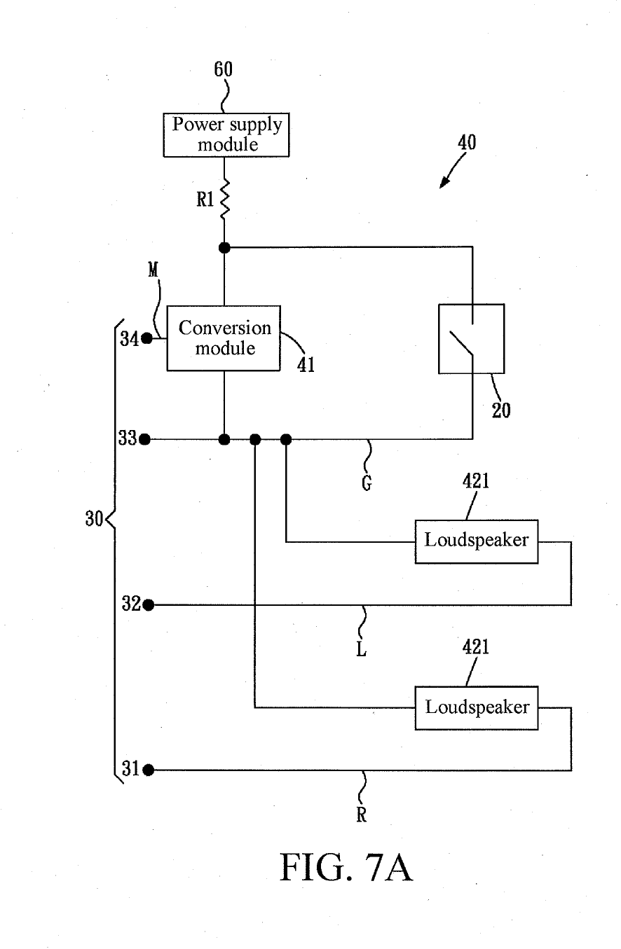

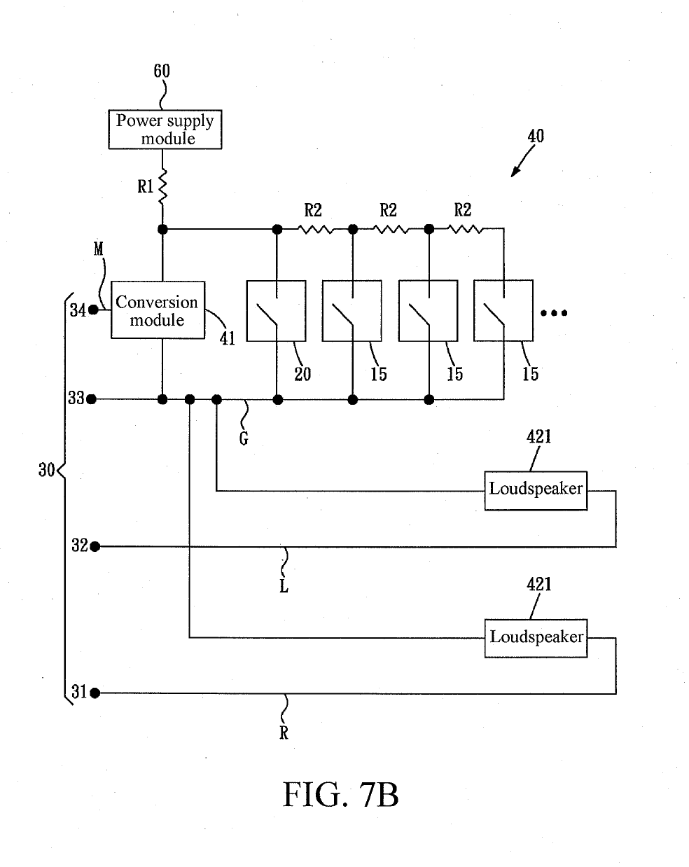

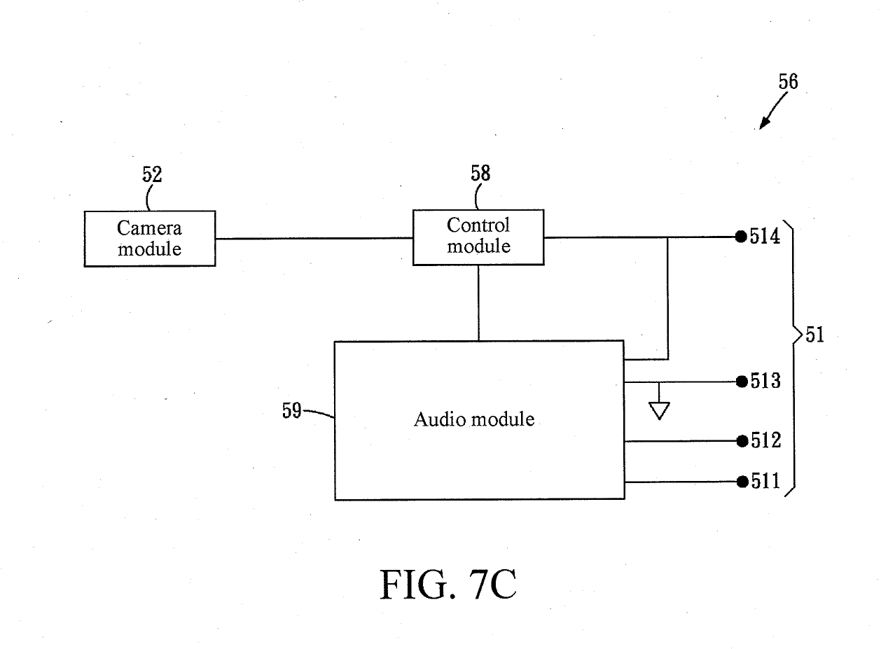

FIG. 7A is a schematic circuit diagram of a trigger circuit 40 according to a fourth embodiment. FIG. 7B is another schematic circuit diagram of the trigger circuit 40 according to the fourth embodiment. FIG. 7C is a schematic circuit diagram of the shutter detection circuit 56 according to the fourth embodiment.

As shown in FIG. 7A to FIG. 7C, the trigger circuit 40 of this embodiment is different from the third embodiment in that, the signal detector 57 as described in the first to third embodiments is disposed in the trigger circuit 40 of the protective shell 1 in this embodiment (and may be referred to as a conversion module 41 in this embodiment). The conversion module 41 is connected electrically between the microphone wire M and the ground wire G. In addition, the conversion module 41 of this embodiment is connected electrically to the power supply module 60 of the protective shell 1, and a resistor R1 may also be provided between the conversion module 41 and the power supply module 60. Similar to the signal detector 57 described above, the conversion module 41 may detect the shutter signal or the control signal generated by the trigger circuit 40, convert the shutter signal into a trigger signal, and output the trigger signal to the audio connector 30. The microphone contact 34 is connected electrically to an output end of the conversion module 41, so as to transmit the trigger signal of the conversion module 41. On the other hand, the microphone pin 514 is directly connected electrically to the control module 58, so that the control module 58 can receive the trigger signal from the conversion module 41.

In this embodiment, the trigger signal may be a signal, a message or an instruction that can be recognized by the control module 58 of the handheld electronic device 50, according to which corresponding operations (such as image capturing, focusing and zooming) are performed.

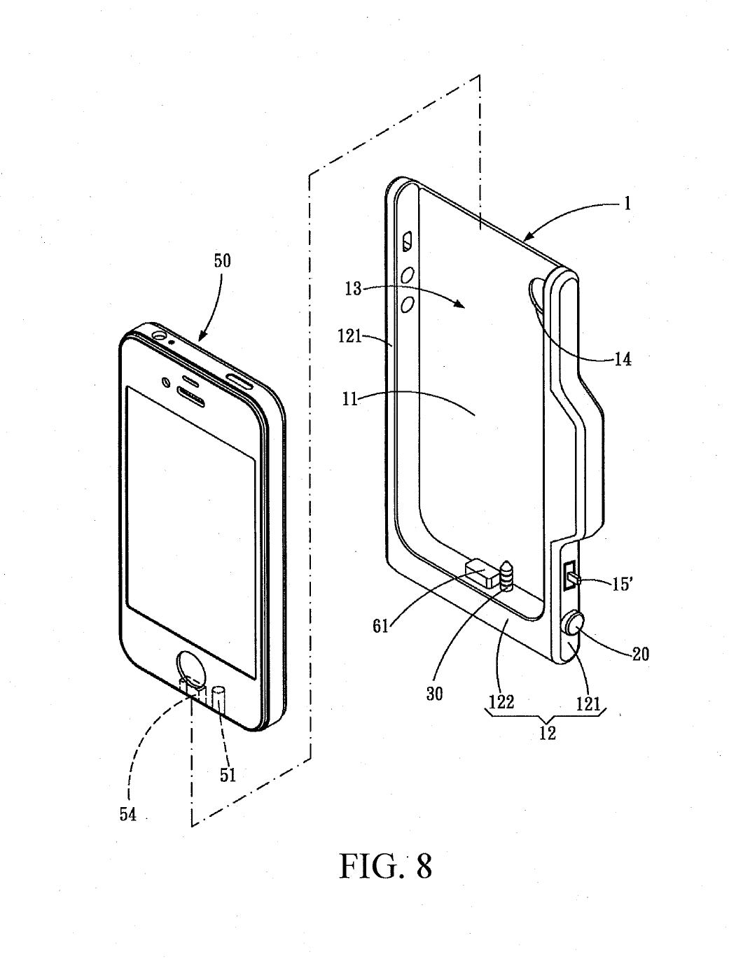

FIG. 8 is a schematic three-dimensional view of a protective shell 1 and a handheld electronic device 50 according to a fifth embodiment.

As shown in FIG. 8, the protective shell 1 and the handheld electronic device 50 of this embodiment are approximately the same as those of the first to fourth embodiments, except that the side wall portion 12 may be provided with a notch. The notch is corresponding to a side edge of the bottom wall portion 11. In addition, the audio connector 30 is located on the side wall portion 12 and opposite to the notch. Therefore, the handheld electronic device 50 can be disposed into the accommodating space 13 through the notch, in such a manner that the audio connection port 51 is connected to the audio connector 30 of the protective shell 1.

In some embodiments, the handheld electronic device 50 further includes an insertion port 54 (for example, a USB or HDMI connection port). The protective shell 1 also has a corresponding connection terminal 61 for being coupled to the insertion port 54 when the handheld electronic device 50 is accommodated in the accommodating space 13. Thus, a power supply required for driving the loudspeaker 421 can be provided through the insertion port 54.

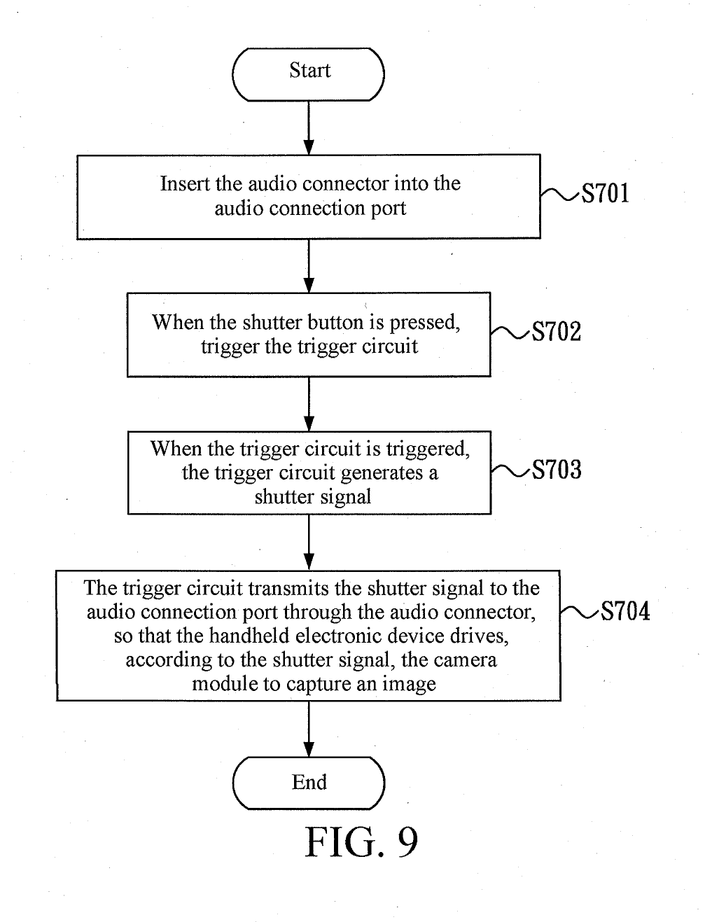

FIG. 9 is a flowchart of an image capturing method using the protective shell 1 and the handheld electronic device 50 according to the first to fourth embodiments.

As shown in FIG. 9, the image capturing method using the handheld electronic device 50 disposed in the protective shell 1 includes the following steps:

Step S701: When the handheld electronic device 50 is disposed in the protective shell 1, the audio connector 30 is inserted into the audio connection port 51.

Step S702: When the shutter button 20 is pressed, the trigger circuit 40 is triggered.

Step S703: When the trigger circuit 40 is triggered, the trigger circuit 40 generates a shutter signal.

Step S704: The trigger circuit 40 transmits the shutter signal to the audio connection port 51 through the audio connector 30, so that the handheld electronic device 50 drives, according to the shutter signal, the camera module 52 to capture an image.

Thus, the handheld electronic device 50 can detect that the user intends to use the camera function of the handheld electronic device 50 or capture an image.

In an embodiment, when the handheld electronic device 50 receives the shutter signal in a camera mode, the handheld electronic device 50 drives the camera module 52 to capture an image; when the handheld electronic device 50 receives the shutter signal in a non-camera mode, the handheld electronic device 50 is switched to the camera mode. That is to say, the shutter signal generated after the user presses the shutter button 20 can drive the handheld electronic device 50 to enter from the non-camera mode into the camera mode, or can drive the handheld electronic device 50 to capture an image.

In some embodiments, for example, the third embodiment described above, the protective shell 1 may include the conversion module 41 for converting the shutter signal into a trigger signal, and transmitting the trigger signal to the handheld electronic device 50 through the audio connector 30 and the audio connection port 51. Whereby, the handheld electronic device 50 can drive, according to the trigger signal, the camera module 52 to capture an image, or can enter from the non-camera mode into the camera mode according to the trigger signal.

In some embodiments, the protective shell 1 may further include the control keys 15 described above. Similar to Step S702 to Step S704, when the control keys 15 are pressed, the trigger circuit 40 is triggered. When the trigger circuit 40 is triggered, the trigger circuit 40 generates a control signal, and transmits the control signal to the audio connection port 51 through the audio connector 30, so that the handheld electronic device 50 generates an the interrupt event.

When detecting the interrupt event in the camera mode, the handheld electronic device 50 exits the camera mode and enters a non-camera mode corresponding to the interrupt event. For example, if the control key 15 corresponding to photograph browsing on the protective shell 1 is pressed when the handheld electronic device 50 is in the camera mode, the handheld electronic device 50 generates the interrupt event of photograph browsing, and accordingly enters a photograph browsing mode. Therefore, after capturing a photograph by the above method, the user can view the captured photograph immediately.

Here, although the description is given through the example where the interrupt event is triggered by the control key 15 corresponding to photograph browsing, the embodiments are not limited thereto, and the interrupt event may not be generated by the corresponding control key 15. For example, when the handheld electronic device 50 is a mobile phone, the interrupt event may be a call request.

In some embodiments, when the control key 15 corresponding to focusing or zooming is pressed, the trigger circuit 40 is triggered. When the trigger circuit 40 is triggered, the trigger circuit 40 generates a control signal. Then, the trigger circuit 40 may transmit the control signal to the audio connection port 51 through the audio connector 30, so that the handheld electronic device 50 performs a focusing or zooming operation corresponding to the control signal. Here, although the description is given through the example where the control key 15 corresponds to focusing or zooming, the embodiments are not limited thereto. The control key 15 may also be other functional keys of a camera, such as ISO setting, white balance setting and menu arrow keys.

In some embodiments, the handheld electronic device 50 may generate an audio signal in the non-camera mode. The handheld electronic device 50 may transmit the audio signal to the protective shell 1 through the audio connection port 51 and the audio connector 30. Then, the protective shell 1 may convert the audio signal into an acoustic wave by using the acoustic module 42.

Generally, when the audio connection port 51 of the handheld electronic device 50 is connected to the audio connector 30, if it is intended to output an audio signal, the audio signal will be output through the audio connection port 51 even if the handheld electronic device 50 has an audio output unit such as a speaker. Therefore, when the handheld electronic device 50 encounters an interrupt event such as an incoming call or music playing, the audio signal may be output to the audio connector 30 through the audio connection port 51, and then transmitted by the audio connector 30 to the loudspeaker 421. As such, a sound can be made from the loudspeakers 421 of the protective shell 1. Thus, the user can listen to the sound corresponding to the audio signal, for example, voice of the caller or music, without removing the protective shell 1.

Based on the above, the protective shell 1 having a shutter pressing structure and the image capturing method according to the embodiments can make it convenient for the user to press the shutter button 20 to capture images when holding the protective shell 1. Since the shutter button 20 is located outside the shell body 10, the user can conveniently press the shutter button 20 to capture images without touching the screen of the handheld electronic device 50. Additionally, when holding the protective shell 1, the user manipulates the handheld electronic device to capture images like using an ordinary camera. Therefore, the protective shell 1 can be held stable by the user, and ensures the user's positive experience of the camera. Furthermore, with the loudspeakers 421 disposed on the protective shell 1, the user can conveniently listen to the sound output by the handheld electronic device 50 without removing the protective shell 1.

While the disclosure has been described by the way of example and in terms of the preferred embodiments, it is to be understood that the disclosure need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A protective shell having a shutter pressing structure, for housing a handheld electronic device, the handheld electronic device comprising an audio connection port and a camera module, the protective shell comprising:
a shell body, comprising an accommodating space for accommodating the handheld electronic device;
a shutter button, located on one side of the shell body opposite to the accommodating space;
an audio connector, located on one side of the shell body adjacent to the accommodating space, and coupled to and signal-connected with the audio connection port when the handheld electronic device is disposed in the accommodating space; and
a trigger circuit, connected electrically between the shutter button and the audio connector, and for transmitting a shutter signal to the camera module through the audio connector and the audio connection port of the handheld electronic device.

2. The protective shell having a shutter pressing structure according to claim 1, wherein the shell body has a bottom wall portion and a side wall portion extending from a periphery of the bottom wall portion, so that the bottom wall portion and the side wall portion define the accommodating space.

3. The protective shell having a shutter pressing structure according to claim 2, wherein the side wall portion is provided with a notch corresponding to a side edge of the bottom wall portion.

4. The protective shell having a shutter pressing structure according to claim 3, wherein the audio connector is located on the side wall portion and opposite to the notch.

5. The protective shell having a shutter pressing structure according to claim 2, wherein the handheld electronic device comprises a back surface abutting the bottom wall portion, the camera module being located on the back surface, and the bottom wall portion is provided with a through hole for exposing the camera module when the handheld electronic device is disposed in the protective shell.

6. The protective shell having a shutter pressing structure according to claim 5, wherein the shutter button is located on one end of a first side wall of the side wall portion, and the through hole is located on the bottom wall portion and corresponding to the other end of the first side wall.

7. The protective shell having a shutter pressing structure according to claim 1, wherein the trigger circuit comprises a conversion module, connected electrically between the shutter button and the audio connector, and for converting the shutter signal into a trigger signal, and outputting the trigger signal to the audio connector.

8. The protective shell having a shutter pressing structure according to claim 1, wherein the trigger circuit comprises an acoustic module, connected electrically to the audio connector, and for receiving an audio signal output by the audio connection port of the handheld electronic device, and converting the audio signal into an acoustic wave.

9. The protective shell having a shutter pressing structure according to claim 8, wherein the acoustic module comprises a loudspeaker.

10. The protective shell having a shutter pressing structure according to claim 1, further comprising at least one control key, located on the side of the shell body opposite to the accommodating space, connected electrically to the audio connector, and for transmitting a control signal to the handheld electronic device through the audio connector and the audio connection port when the shutter button is pressed, wherein the at least one control key and the shutter button form a coded switches group.

11. An image capturing method using a handheld electronic device disposed in a protective shell, wherein the handheld electronic device comprises an audio connection port and a camera module, and the protective shell comprises a shutter button, a trigger circuit and an audio connector, the image capturing method comprising:
inserting the audio connector into the audio connection port;
when the shutter button is pressed, triggering the trigger circuit;
when the trigger circuit is triggered, the trigger circuit generating a shutter signal; and
the trigger circuit transmitting the shutter signal to the audio connection port through the audio connector, so that the handheld electronic device drives, according to the shutter signal, the camera module to capture an image.

12. The image capturing method according to claim 11, wherein when the handheld electronic device receives the shutter signal in a camera mode, the handheld electronic device drives the camera module to capture an image, and when the handheld electronic device receives the shutter signal in a non-camera mode, the handheld electronic device is switched to the camera mode.

13. The image capturing method according to claim 12, wherein the handheld electronic device detects in the camera mode whether an interrupt event occurs, and when detecting the interrupt event, the handheld electronic device exits the camera mode and enters a non-camera mode corresponding to the interrupt event.

14. The image capturing method according to claim 13, wherein the protective shell further comprises a control key, and the image capturing method further comprises:
when the control key is pressed, triggering the trigger circuit;
when the trigger circuit is triggered, the trigger circuit generating a control signal; and
the trigger circuit transmitting the control signal to the audio connection port through the audio connector, so that the handheld electronic device generates the interrupt event.

15. The image capturing method according to claim 14, wherein the handheld electronic device receives the control signal and enters the interrupt event of photograph browsing.

16. The image capturing method according to claim 14, wherein the control key and the shutter button are connected by a resistor to form a coded switches group.

17. The image capturing method according to claim 13, wherein the protective shell further comprises a control key, and the image capturing method further comprises:
when the control key is pressed, triggering the trigger circuit;
when the trigger circuit is triggered, the trigger circuit generating a control signal; and
the trigger circuit transmitting the control signal to the audio connection port through the audio connector, so that the handheld electronic device performs a focusing or zooming operation corresponding to the control signal.

18. The image capturing method according to claim 17, wherein the control key and the shutter button are connected by a resistor to form a coded switches group.

19. The image capturing method according to claim 12, wherein the protective shell further comprises an acoustic module, and the image capturing method further comprises:
the handheld electronic device generating an audio signal in the non-camera mode;
the handheld electronic device transmitting the audio signal to the protective shell through the audio connection port and the audio connector; and
the acoustic module converting the audio signal into an acoustic wave.

20. The image capturing method according to claim 11, wherein the protective shell further comprises a conversion module for converting the shutter signal into a trigger signal, and transmitting the trigger signal to the audio connection port through the audio connector, so that the handheld electronic device drives, according to the trigger signal, the camera module to capture an image.
